(19) United States
(12) Patent Application Publication
(10) Pub. No.: US 2007/0078925 A1
(43) Pub. Date: Apr. 5, 2007

(54) Porting an interface defining document between mobile device platforms

(75) Inventors: Timothy Allen Neil, Mississauga (CA); Steven Robert Grenier, Georgetown (CA)

Correspondence Address: SMART AND BIGGAR, 438 UNIVERSITY AVENUE, SUITE 1500 BOX 111, TORONTO, ON, M5G2K8, CA

(73) Assignee: RESEARCH IN MOTION LIMITED

(21) Appl. No.: 11/235,387

(22) Filed: Sep. 27, 2005

(51) Int. Cl. G06F 15/16

(52) U.S. Cl. 709/201

(57) ABSTRACT

A wireless communication device may be configured with an application definition file, for interaction with an application executing at a server computing device. Using definitions for a user interface provided by the application definition file, the wireless device may present a user interface for the application. Preferably, the application definition file is an XML file. Based on differences between a source wireless communication device platform, for which screen control elements of the user interface found within the application definition file may be defined, and a desired destination wireless communication device platform, the screen control elements may be converted. Advantageously, the application definition file, when updated to include the converted screen control elements, may be used by a device executing the destination wireless communication device platform.

### COPYRIGHT NOTICE

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyright rights whatsoever.

### FIELD OF THE INVENTION

The present patent application relates to software, devices and methods allowing varied mobile devices to interact with server side software applications and, more particularly, to the configuration of such mobile devices. Furthermore, where a given document is used to configure a first mobile device for interacting with server side software applications, the present invention relates to porting the given document for configuring a second mobile device, where the second mobile device operates on a platform distinct from the platform of the first mobile device.

### BACKGROUND

Wireless connectivity is a feature of the modern telecommunications environment. An increasing range of people are using a wide variety of wireless data networks to access corporate data applications.

However, there are numerous competing mobile devices that can be used to achieve this. Each device has its own operating system and its own display characteristics. Operating systems are not mutually compatible, nor are the display characteristics—some are color, some are black and white, some are text-only, some are pictorial.

At the same time, an increasing number of mobile device users are people without a technical background or high level of educational achievement. Such people are often intimidated by the need to run complex installation programs. Furthermore, at present, such installation programs generally depend on cable connections to a personal computer by the means of a “cradle” or other such device.

Therefore, a mechanism whereby a mobile client for a server side application may be enabled for multiple wireless devices with minimal modification of the application at the server is required. Further, the ability to install and upgrade the application onto mobile devices wirelessly without the need for human intervention or connection to PCs, is desirable.

### BRIEF DESCRIPTION OF THE DRAWINGS

In figures that illustrate, by way of example, embodiments:

FIG. 1 schematically illustrates a mobile device, exemplary of an embodiment of this application, including virtual machine software, further exemplary of an embodiment of this application;

FIG. 2 further illustrates the organization of an exemplary virtual machine at the mobile device of FIG. 1;

FIG. 3 illustrates an operating environment for the device of FIG. 1 including a middleware server;

FIG. 4 illustrates the structure of an example application definition file stored at the middleware server of FIG. 3 used by the device of FIG. 1;

FIG. 5 schematically illustrates the formation of application definition files at the middleware server of FIG. 3;

FIG. 6 schematically illustrates the middleware server of FIG. 3, exemplary of an embodiment of this application, including a database, further exemplary of an embodiment of this application;

FIG. 7 is a flow diagram illustrating the exchange of sample messages passed between the mobile device, the middleware server and the backend application server of FIG. 3;

FIG. 8 illustrates steps performed at a mobile device under control of the virtual machine of FIG. 2;

FIG. 9 illustrates steps performed at a mobile device under control of the virtual machine of FIG. 2;

FIG. 10 illustrates steps performed at a mobile device under control of the virtual machine of FIG. 2;

FIG. 11 illustrates the format of messages exchanged in the message flow of FIG. 7;

FIG. 12 illustrates a presentation of a user interface for a sample application at a mobile device;

FIG. 13 illustrates a sample portion of an application definition file defining the user interface illustrated in FIG. 12;

FIG. 14 illustrates the format of a message formed in accordance with the sample portion of the application definition file of FIG. 13;

FIG. 15A illustrates a sample portion of an application definition file defining a local storage at a mobile device;

FIG. 15B schematically illustrates local storage in accordance with FIG. 15A;

FIG. 15C illustrates how locally stored data is updated by a sample message in accordance with the sample portion of an application file definition of FIG. 15A;

FIG. 16 illustrates screen elements displayed on a typical PocketPC device;

FIG. 17 illustrates screen elements displayed on a typical Palm device;

FIG. 18 illustrates steps in a method performed by a file management tool while interacting with a user to trigger conversion of screen control elements; and

FIG. 19 illustrates steps in a method of converting screen control elements for use in an application definition file for a destination platform.

### DETAILED DESCRIPTION

In accordance with the present application, data from an application executing at a computing device is presented at a remote wireless device. The device is provided with an application definition file that contains: definitions for a user interface format for the application at the wireless device; a format of network messages for exchange of data generated by the application; and a format for storing data related to the application at the wireless device. Using the definitions, the wireless device may receive data from the application and present an interface for the application. Preferably, the application definition file is an XML file. Similarly, application specific network messages provided to the device are also formed using XML. In the preferred embodiment, the data from the application is presented at the mobile device by virtual machine software that uses the application definition file.

Notably, the part of the application definition file that relates to the display of screen elements is typically developed specifically for a given type of wireless communication device. Based on differences between a source wireless communication device platform, for which screen control elements of the user interface found within the application definition file may be defined, and a desired destination wireless communication device platform, the screen control elements may be converted. Advantageously, the application definition file, when updated to include the converted screen control elements, may be used by a device executing the destination wireless communication device platform.

In accordance with an aspect of the present application, there is provided a method of converting a portion of a document, developed for configuring a first mobile communication device with a first platform, to generate a new document portion for configuring a second mobile communication device with a second platform. The method includes receiving a portion of the first document, where the portion of the first document is specific to the first platform, parsing the portion of the first document to identify a plurality of screen control elements, defining a new screen control element based on an original screen control element from among the plurality of screen control elements, where the defining incorporates limitations specific to the second platform, and replacing, in the portion of the first document, the original screen control element with the new screen control element. In other aspects of the application, computing device is provided for carrying out the method and a computer readable medium is provided to allow a processor to carry out the method.

Other aspects and features of the present application will become apparent to those of ordinary skill in the art, upon review of the following description of specific embodiments of the application in conjunction with the accompanying figures.

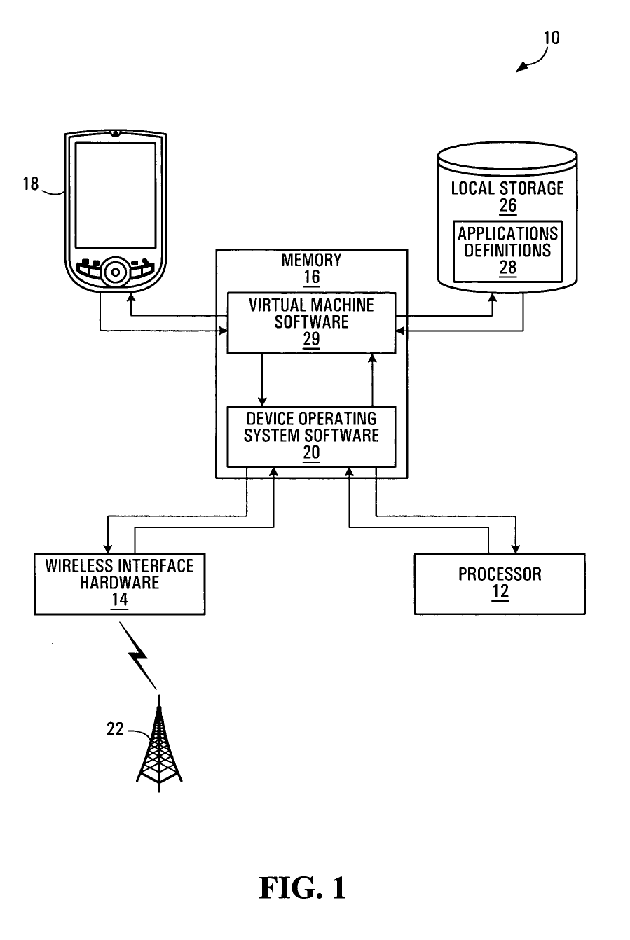

FIG. 1 illustrates elements of a mobile device 10, exemplary of an embodiment of the present application, in communication with a wireless network 22. The mobile device 10 may be any conventional mobile device, modified to function in manners exemplary of the present application. As such, elements of the mobile device 10 include a processor 12, a network interface 14, a storage memory 16 and a user interface 18 typically including a keypad and/or touch-screen. The network interface 14 enables the device 10 to transmit and receive data over the wireless network 22. The mobile device 10 may be, for example, be a WinCE based device, a PalmOS device, a WAP enabled mobile telephone, or the like. The storage memory 16 of the device 10 stores operating system software 20 providing a mobile operating system such as the PalmOS or WinCE. The operating system software 20 typically includes graphical user interface software and network interface software having suitable application programming interfaces (APIs) for use by other applications executing at the device 10.

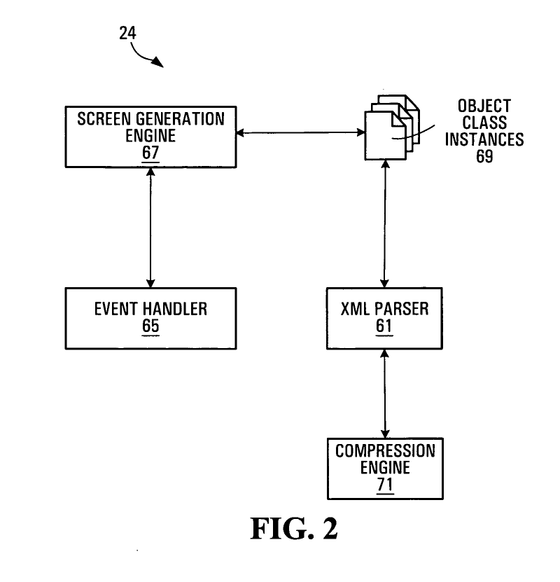

The storage memory 16 at the device 10 further stores virtual machine software 29, exemplary of an embodiment of the present application. The virtual machine software 29, when executed by the mobile device 10, enables the device 10 to present an interface, for a server side application provided by a middleware server, as described below. Specifically, a virtual machine 24 (see FIG. 2), which exists through an execution of the virtual machine software 29 on the processor 12, interprets a text application definition file defining: a user interface 18 controlling application functionality and the display format (including display flow) at the device 10 for a particular server side application; the format of data to be exchanged over the wireless network 22 for the particular server side application; and the format of data to be stored locally at the device 10 for the particular server side application. The virtual machine 24 uses the operating system software 20 and associated APIs to interact with the device 10, in accordance with the received application definition file. In this way, the device 10 may present interfaces for a variety of server side applications, executed at a variety of servers. Moreover, multiple wireless devices may use a common server side application, as each wireless device executes a similar virtual machine that interprets an application definition file to present a user interface and program flow specifically adapted for the device.

As such, and as will become apparent, the exemplary virtual machine software is specifically adapted to work with the particular mobile device 10. Thus, if the device 10 is a PalmOS or WinCE device, the virtual machine 24 that results from executing the exemplary virtual machine software 29 is, correspondingly, a PalmOS virtual machine or a WinCE virtual machine. As further illustrated in FIG. 1, the virtual machine 24 is capable of accessing the local storage 26 at the device 10.

Other applications, libraries and software may also be present within the memory 16 or the local storage 26 and are not specifically illustrated. For example, the device 10 may store and execute personal information management (PIM) software, including calendar and contact management applications. Similarly, the device 10 could store and execute software allowing the device 10 to perform a number of functions. Software could, for example, interact with the hardware at the device 10 to allow the device 10 to act as a multimedia player; allowing the device 10 to print; allowing the device 10 to interact with other incorporated hardware not specifically illustrated, including, but not limited to, a Bluetooth interface; a Global Positioning Satellite (GPS) Receiver; and the like. The memory 16 may also store software components in the form of object classes that may be used to extend the functionality of the virtual machine 24. As will become apparent, these external software components in the form of object classes allow the virtual machine 24 to become extensible. The object classes may, for example, allow the virtual machine 24 to access additional hardware or software local to the device 10.

As detailed below, an exemplary application definition file may be formed using a markup language, such as the known eXtensible Markup Language (XML) or a variant thereof. In accordance with an embodiment of the present application, defined XML entities are understood by the virtual machine 24. Defined XML entities are detailed in Appendix “A”, appended hereto. The defined XML entities are interpreted by the virtual machine 24 and may be used as building blocks to present an interface, at the mobile device 10, to server side applications, as detailed herein.

Specifically, as illustrated in FIG. 2, the virtual machine software 29 includes: conventional XML parser software; event handler software; screen generation engine software; and object classes. The virtual machine software 29, when executed leads to the virtual machine 24, which includes: an XML parser 61; an event handler 65; a screen generation engine 67; and instances of the object classes 69. The object classes correspond to XML entities supported by the virtual machine software 29 and possibly other XML entities contained within an application definition file. Supported XML entities are detailed in Appendix “A” hereto enclosed. A person of ordinary skill will readily appreciate that those XML entities identified in Appendix “A” are exemplary only and may be extended or shortened as desired.

The XML parser 61 may be formed in accordance with the Document Object Model, or DOM, available at www.w3.org/DOM/, the contents of which are hereby incorporated by reference. The XML parser 61 enables the virtual machine 24 to read an application description file. Using the XML parser 61, the virtual machine 24 may form a binary representation of the application definition file for storage at the mobile device 10, thereby eliminating the need to parse text each time an application is used. The XML parser 61 may convert each XML tag contained in the application definition file, and its associated data, to tokens, for later processing. As will become apparent, this may avoid the need to repeatedly parse the text of an application description file.

The screen generation engine 67 orchestrates the display of initial and subsequent screens at the mobile device 10 in accordance with an application description file 28, as detailed below.

The event handler 65 allows the virtual machine 24 to react to certain external events. Example events include user interaction with presented screens or display elements, incoming messages received from a wireless network, or the like.

The object classes define objects that allow the mobile device 10 to process each of the supported XML entities. Each of the object classes includes: attributes, which are used to store parameters defined by the XML file and functions allowing the XML entity to be processed at the mobile device, as detailed in Appendix “A”, for each supported XML entity. So, as should be apparent, supported XML entities are extensible. The virtual machine software 29 may be expanded to support XML entities not detailed in Appendix “A”. Corresponding object classes could be added to the virtual machine software 29.

As detailed below, upon invocation of a particular application at the mobile device 10, the virtual machine 24 presents an initial screen on the user interface 18 based on the contents of the application definition file 28. Screen elements are created by the screen generation engine 67 by creating instances 69 of corresponding object classes for defined elements. The object class instances 69 are created using attributes contained in the application definition file 28. Thereafter the event handler 65 of the virtual machine 24 reacts to events for the application. Again, the event handler 65 consults the contents of the application definition file 28 for the application in order to properly react to events. Events may be reacted to by creating instances of associated “action” objects from the object classes.

Similarly, the object classes of the virtual machine software 29 further include object classes corresponding to data tables and network transactions defined in the Table Definition and Package Definition sections of Appendix “A”. At run time, instances 69 of object classes corresponding to these classes are created and populated with parameters contained within the application definition file 28, as required.

Using this general description, persons of ordinary skill in the art will be able to form the virtual machine software 29 for any particular device. Typically, the virtual machine software 29 may be formed using conventional object oriented programming techniques and existing device libraries and APIs, as to function as detailed herein. As will be appreciated, the particular format of the screen generation engine 67 and the object class instances 69 will vary depending on the type of virtual machine software, the device operating system and the APIs available at the device. Once formed, a machine executable version of the virtual machine software 29 may be loaded and stored at the mobile device 10, using conventional techniques. The machine executable version of the virtual machine software can be embedded in ROM, loaded into RAM over a network or loaded into RAM from a computer readable medium. Although, in the preferred embodiment the virtual machine software is formed using object oriented structures, persons of ordinary skill will readily appreciate that other approaches could be used to form suitable virtual machine software. For example, the object classes forming part of the virtual machine software 29 could be replaced by equivalent functions, data structures or subroutines formed using a conventional (i.e., non-object oriented) programming environment. Operation of the virtual machine 24 while consulting an application definition file containing various XML definitions exemplified in Appendix “A”, is further detailed below.

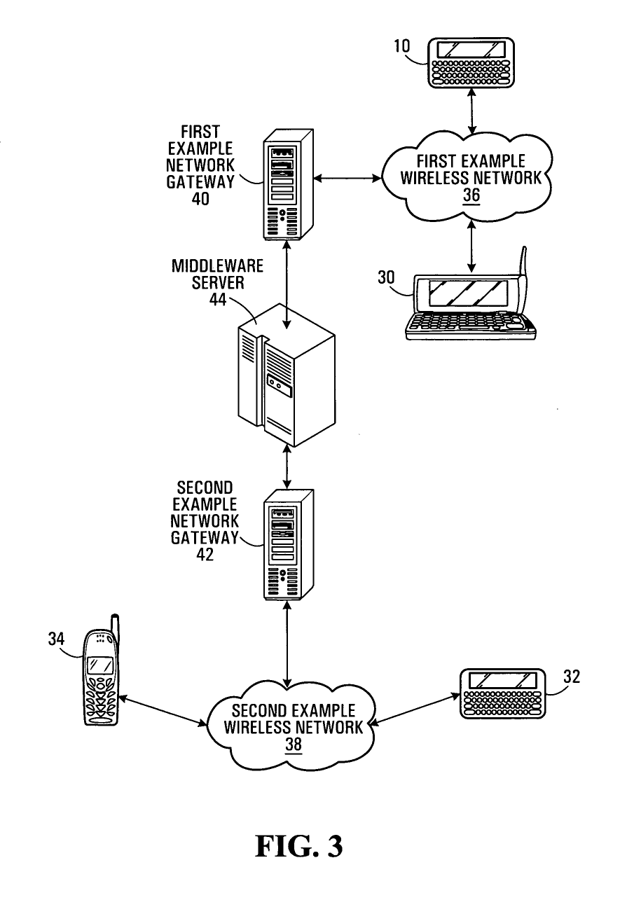

FIG. 3 illustrates the operating environment for the first example mobile device 10. Further example mobile devices, including a second example mobile device 30, a third example mobile device 32 and a fourth example mobile device 34 are also illustrated in FIG. 3. These further example mobile devices 30, 32 and 34 are similar to the first example mobile device 10 and also store and execute virtual machine software exemplary of an embodiment of the present application.

Virtual machines, like the virtual machine 24 executed at the first example mobile device 10, execute on each of the further example mobile devices 30, 32, 34, and communicate with a middleware server 44 by way of a first example wireless network 36, a second example wireless network 38, a first example network gateway 40 and a second example network gateway 42. The example gateways 40, 42 are generally available as a service for those people wishing to have data access to wireless networks. An example network gateway is available from Broadbeam Corporation, of Cranbury, N.J., in association with the trademark SystemsGo!. The wireless networks 36, 38 are further connected to one or more computer data networks, such as the Internet and/or private data networks by way of the example gateways 40, 42. As will be appreciated, the application may work with many types of wireless networks. The middleware server 44 is, in turn, in communication with a data network that is in communication with the example wireless networks 36, 38. The communication protocol used for such communication may be TCP/IP over an HTTP transport. As could be appreciated, other network protocols such as X.25 or SNA could equally be used for this purpose.

The mobile devices 10, 30, 32, 34 communicate with the middleware server 44 in two ways. First, the virtual machine at each device may query the middleware server 44 for a list of applications of which a user of an associated mobile device 10, 30, 32, 34 can make use. If a user decides to use a particular application, the corresponding mobile device 10, 30, 32, 34 can download a text description, in the form of an application definition file, for the particular application from the middleware server 44 over its wireless interface. As noted, the text description is preferably formatted using XML. Second, the virtual machine at each device may send, receive, present and locally store data related to the execution of applications, or its own internal operations. The format of exchanged data for each application is defined by an associated application description file. Again, the exchanged data is preferably formatted using XML in accordance with the application description file.

The middleware server 44, in turn, stores text application description files for those applications that have been enabled to work with the various mobile devices 10, 30, 32, 34 in a pre-defined format understood by the corresponding virtual machines. Software providing the functions of the middleware server 44 in the exemplary embodiment is written in Delphi and uses an SQL Server database.

As noted, text files defining application definitions and data may be formatted in XML. For example, XML version 1.0, detailed in the XML version 1.0 specification second edition, dated Oct. 6, 2000 and available at the internet address www.w3.org/TR/2000/REC-xml-2000-1006, the contents of which are hereby incorporated herein by reference, may be used. However, as will be appreciated by those of ordinary skill in the art, the functionality of storing XML description files is not dependent on the use of any given programming language or database system.

Each application definition file is formatted according to defined rules and uses pre-determined XML markup tags, known to both the virtual machine executed at the mobile device and the complementary server software executed at the middleware server 44. Tags define XML entities, which are used as building blocks to present an interface to an application at a mobile device. Knowledge of these rules, and an understanding of how each tag and section of text should be interpreted, allows the virtual machine executed at the mobile device to process an XML application definition file and thereafter provide an interface to an application executed at an application server, as described below. The virtual machine effectively acts as an interpreter for a given application definition file.

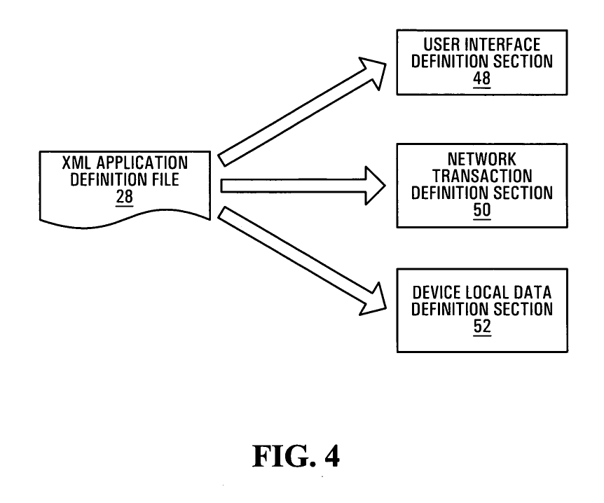

FIG. 4 illustrates an example format for an XML application definition file 28. As illustrated, the example application definition file 28 for a given mobile device and server side application includes three components: a user interface definition section 48, specific to the user interface for the mobile device 10, that defines the format of screen or screens for the application and how the user interacts with the screens; a network transactions definition section 50 that defines the format of data to be exchanged with the application; and a local data definition section 52 that defines the format of data to be stored locally on the mobile device by the application.

Defined XML markup tags correspond to XML entities supported at a mobile device and are used to create an application definition file 28. The defined tags may broadly be classified into three categories, corresponding to the three sections 48, 50 and 52 of an application definition file 28.

Example XML tags and their corresponding significance are detailed in Appendix “A”. As noted above, the virtual machine software 29 at the mobile device 10 includes object classes corresponding to each of the XML tags. At run time, instances of the objects are created as required.

Broadly, the following example XML tags may be used to define the user interface:

<SCREEN>—this tag defines a screen such that a SCREEN tag pair contains the definitions of the screen control elements (buttons, radio buttons and the like) and the events associated with the screen and the screen control elements of the screen;

<BTN>—this tag defines a button and attributes associated with the button;

<LIST>—this tag defines a list box;

<CHOICEBOX>—this tag defines a choice item, which allows selection of a value from predefined list;

<MENU>—the application developer will use this tag to define a menu for a given screen;

<EDITBOX>—this tag defines an edit box;

<TEXT ITEM>—this tag describes a text label that is to be displayed;

<CHECKBOX>—this tag describes a checkbox;

<HELP>—this tag defines a help topic that is used by another element on the screen;

<IMAGE>—this tag describes an image that appears on those displays that support images;

<ICON>—this tag describes an icon;

<EVENT>—this tag defines an event to be processed by the virtual machine 24 (events can be defined against the application as a whole, individual screens or individual items on a given screen; sample events include: receipt of data over the wireless interface; and an edit of text in an edit box); and

<ACTION>—this tag defines a particular action that might be associated with an event handler (sample actions include: navigating to a new window; and displaying a message box.).

The second category of example XML tags may be used in the network transaction section 50 of the application definition file 28. These may include the following example XML tags:

<TABLEUPDATE>—using this tag, the application developer can define an update that is performed to a table in the device-based local storage 26 (attributes of this tag allow the update to be performed against multiple rows in a given table at once); and

<PACKAGEFIELD>—this tag defines a field in an XML package that passes over the wireless interface.

The third category of XML tags are those used to define a logical database that may be stored in local storage 26 at the mobile device 10. The tags available that may be used in this section are:

<TABLE>—this tag, along with its attributes, defines a table (contained within a pair of <TABLE> tags are definitions of the fields contained in that table; the attributes of a table control such standard relational database functions as the primary key for the table); and

<FIELD>—this tag defines a field and its attributes (attributes of a field are those found in a standard relational database system, such as the data type, whether the field relates to a field in a different table, the need to index the field and so on).

The virtual machine 24 may, from time to time, need to perform certain administrative functions on behalf of a user. In order to do this, one of the object classes is associated with a repertoire of tags to communicate needs to the middleware server 44. Such tags differ from the previous three groupings in that they do not form part of an application definition file, but are solely used for administrative communications between the virtual machine 24 and the middleware server 44. XML packages using these tags are composed and sent due to user interactions with configuration screens of the virtual machine 24. The tags used for this include:

<REG>—this tag allows the application to register and deregister a user for use with the middleware server 44;

<FINDAPPS>—by using this tag, users can interrogate the middleware server 44 for a list of available applications;

<APPREG>—using this tag, a mobile device can register (or deregister) for an application and have the application definition file downloaded automatically (or remove the application definition file from the device-based local storage 26); and

<SETACTIVE>—using this tag, the user is allowed to identify the device that the user is currently using as the active device (if the user's preferred device is malfunctioning, or out of power or coverage, the user may need a mechanism to tell the middleware server 44 to attempt delivery to a different device).

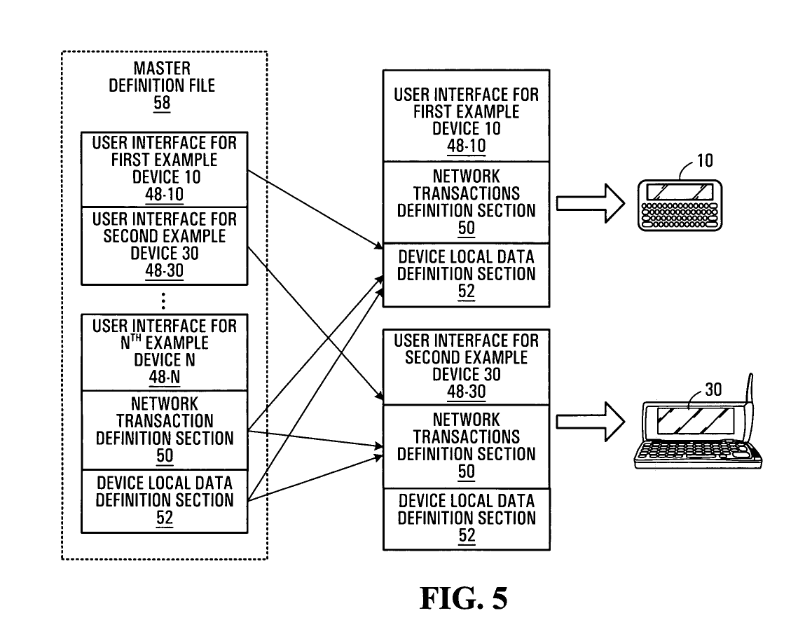

FIG. 5 illustrates the organization of application definition files at the middleware server 44 and how the middleware server 44 may form an application definition file 28 (FIG. 4) for a given one of the example mobile devices 10, 30, 32, 34. In the illustration of FIG. 5, only the first example mobile device 10 and the second example mobile device 30 are considered. Typically, since network transactions and local data are the same across devices, the only portion of the application definition file that varies for different devices is the user interface definition section 48.

As such, the middleware server 44 stores a master definition file 58 for a given server side application. This master definition file 58 contains: an example user interface definition section 48-10 for the first example mobile device 10 of FIG. 1; an example user interface definition section 48-30 for the mobile device 30 of FIG. 3; an example user interface definition section 48-N for an Nth mobile device; a description of the network transactions that are possible in the network transactions definition section 50; and a definition of the data to be stored locally on the mobile device in the local data definition sections 52. Preferably, the network transactions definition section 50 and the local data definition sections 52 will be the same for all example mobile devices 10, 30, . . . , N.

For the first example mobile device 10, the middleware server 44 composes the application definition file 28 by querying the device type and adding the user interface definition section 48-10 for the first example mobile device 10 to the definition sections 50, 52 for the network transactions and the device local data. For the second example mobile device 30, the middleware server 44 composes the application definition file by adding the user interface definition section 48-30 for the second example mobile device 30 to the definition sections 50, 52 for the network transactions and the device local data.

The master definition file 58 for a given application is likely to be created away from the middleware server 44 and loaded onto the middleware server 44 by administrative staff charged with the operation of the middleware server 44. Master definition files could be created either by use of a simple text editor or by a graphical file generation tool. Such a graphical file generation tool might generate part or all of the file, using knowledge of the XML formatting rules, based on the user's interaction with screen painters, graphical data definition tools and the like.

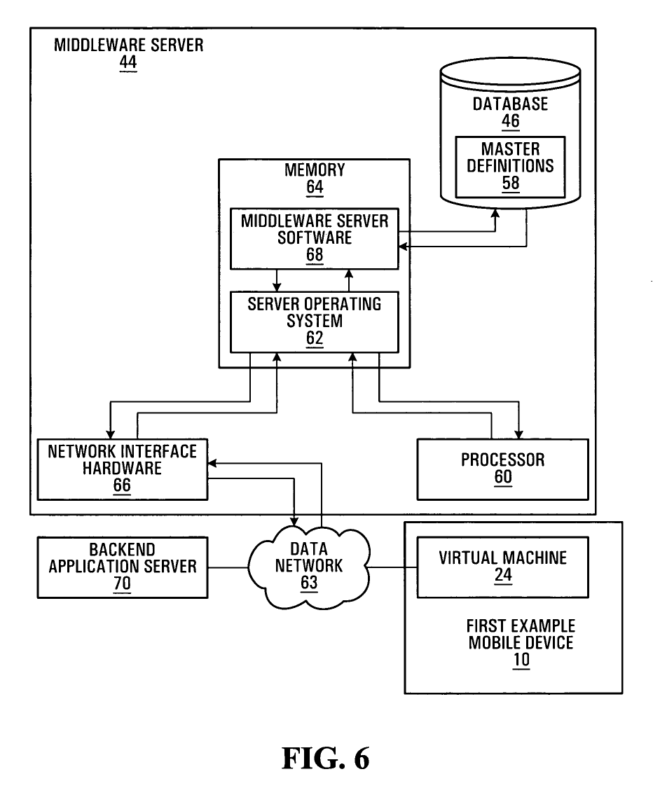

FIG. 6 illustrates the organization of middleware server 44 and associated master definition files. The middleware server 44 may be any conventional application server modified to function in manners exemplary of the present application. As such, the middleware server 44 includes a processor 60, a network interface 66, a storage memory 64 and a server database 46. The middleware server 44 may, for example, be a Windows NT server, a Sun Solaris server, or the like. Correspondingly, the storage memory 64 of the middleware server 44 stores a server operating system 62 such as Windows NT or Solaris.

The network interface hardware 66 enables the middleware server 44 to transmit and receive data over a data network 63. Transmissions are used to communicate with both the virtual machine 24 of the first example mobile device 10, via the wireless networks 36, 38 and the wireless gateways 40, 42, and a backend application server 70, which may be considered representative of one or more application servers. The backend application server 70 may be considered both the end recipient of data received by the middleware server 44 from the mobile devices and the generator of data that is to be sent by the middleware server 44 to the mobile devices.

The storage memory 64 at the middleware server 44 further stores middleware server software 68, exemplary of an embodiment of an aspect of the present application. The middleware server software 68, when executed by the processor 60 of the middleware server 44, enables the middleware server 44 to compose and understand XML packages that are sent by and received by the middleware server 44. These XML packages may be exchanged between the middleware server 44 and the first example mobile device 10 or between the middleware server 44 and the backend application server 70.

As mentioned above, communication between the backend application server 70 and the middleware server 44 may use HTTP running on top of a standard TCP/IP stack. An HTTP connection between a running application at the backend application server 70 and the middleware server 44 may be established in response to receipt of an XML package from a mobile device. The server side application executed at the backend application server 70 provides output to the middleware server 44 over this connection. The server side application output may be formatted, by the server side application, into appropriate XML packages understood by the virtual machine 24 at the first example mobile device 10.

That is, a given server side application (or an interface portion of the server side application) formats server side application output into an XML package in a manner consistent with a format defined in the application definition file for the given server side application. Alternatively, an interface component, separate from the server side application, could easily be formed with an understanding of the format for output for the given server side application. That is, with a knowledge of the format of data provided by and expected by the given server side application at the backend application server 70, an interface component could be a produced using techniques readily understood by those of ordinary skill. The interface component could translate the output of the given server side application to an XML package, as expected by the middleware server 44. Similarly, the interface portion may translate an XML package received, via the middleware server 44, from the mobile device 10 into a format understood by the given server side application.

The particular identity of the mobile device on which the interface to the server side application is to be presented may be specified by a suitable identifier, contained in a header prefixed to the server side application output XML package. This header may be used by the middleware server 44 to determine the appropriate mobile device to which to forward the XML package. Alternatively, the identity of the connection between the backend application server 70 and the middleware server 44 could be used to determine, at the middleware server 44, the appropriate mobile device to which to forward the XML package.

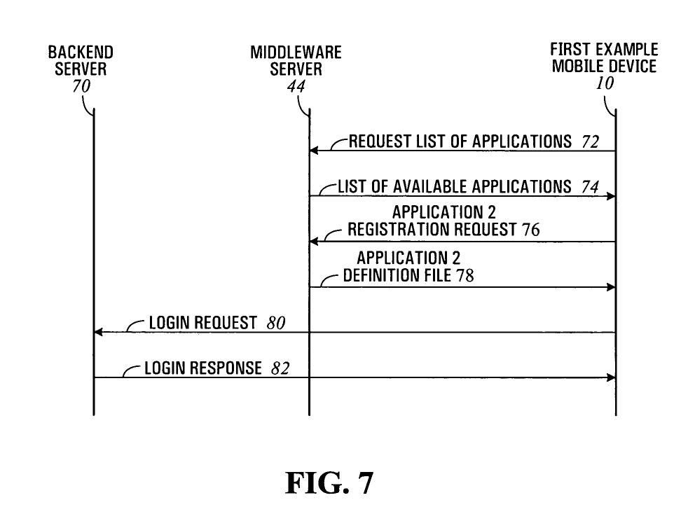

FIG. 7 illustrates a flow diagram detailing data flow (application data or application definition files 28) between the mobile device 10 and the middleware server 44, in manners exemplary of an embodiment of the present application.

For data requested from the middleware server 44, the device 10, under software control by the virtual machine software, transmits requests to the middleware server 44 (see also FIG. 3), which requests pass over the first wireless network 36 to the first network gateway 40. The first network gateway 40 passes the request to the middleware server 44. The processor 60 of the middleware server 44 responds by executing a database query on the server database 46. The response to the query is an indication of the applications that are available to the user and the mobile device 10. Data representative of the indication is passed, by the middleware server 44, to the first network gateway 40. The first network gateway 40 forwards the data representative of the indication to the mobile device 10 over the first wireless network 36.

FIG. 7, when considered with FIG. 3, illustrates a sequence of communications, between the virtual machine 24 at the device 10 and the middleware server 44, that may occur when the user of the mobile device 10 wishes interact with a server side application. Accordingly, initially, the virtual machine 24 interrogates the middleware server 44 to determine the applications that are available for the first example mobile device 10. This interrogation may be initiated by the user instructing the virtual machine 24 at the first example device 10 to interrogate the middleware server 44. Responsive to these instructions, the virtual machine 24 composes an XML package requesting the list of applications. The wireless interface hardware 14 (see FIG. 1) of the mobile device 10 transmits the XML package to the middleware server 44 (data flow 72). The XML message may be composed to contain a <FINDAPPS> tag, signifying, to the middleware server 44, a desire for a list of available applications. In response, the middleware server 44 makes a query to the server database 46. The server database 46, responsive to this query, returns a list of applications that are available to the user and to the first example mobile device 10. The list is typically based, at least in part, on the type of mobile device making the request, the identity of the user of the mobile device and the applications known to the middleware server 44. The middleware server 44 converts the list into an XML list package and transmits the XML list package, including a list of available applications, to the mobile device 10 (data flow 74). Again, a suitable XML tag identifies the XML list package as containing a list of available applications.

In response to being presented with the list of available applications, a user at the first example device 10 may choose to register for an available server side application in the list. When the user chooses to register for an application, the virtual machine 24 at the device 10 composes a registration request XML package containing a registration request for the selected application. The wireless interface hardware 14 transmits the registration request XML package to the middleware server 44 (data flow 76). The registration request XML package may contain a <REG> tag. The name of the application is specified in the registration request XML package. The middleware server 44, in response to receiving the registration request XML package, queries the server database 46 for a user interface definition associated with the specified application and the first example mobile device 10. Thereafter, the middleware server 44 creates the application definition file, as detailed with reference to FIG. 5. Then, the middleware server 44 composes an XML package including the composed application definition file and transmits the XML package to the mobile device 10 (data flow 78).

The user is then able to use the functionality defined by the application definition file to send and receive data.

After receiving the XML package including the application definition file, the XML parser 61 of the virtual machine 24 may parse the XML text of the application definition file to form a tokenized version of the application definition file. That is, each XML tag of the application definition file may be converted to a defined token for compact storage and to minimize repeated parsing of the XML text file. The tokenized version of the application definition file may then be stored for immediate or later use by the device 10.

Thereafter, upon invocation of an interface to the particular application for which the device 10 has registered, the screen generation engine 67 of the virtual machine 24 locates the definition of an initial screen for the particular application. The initial screen may be identified within the application definition file for the particular application as corresponding to a <SCREEN> tag with an associated attribute of First screen=“yes”.

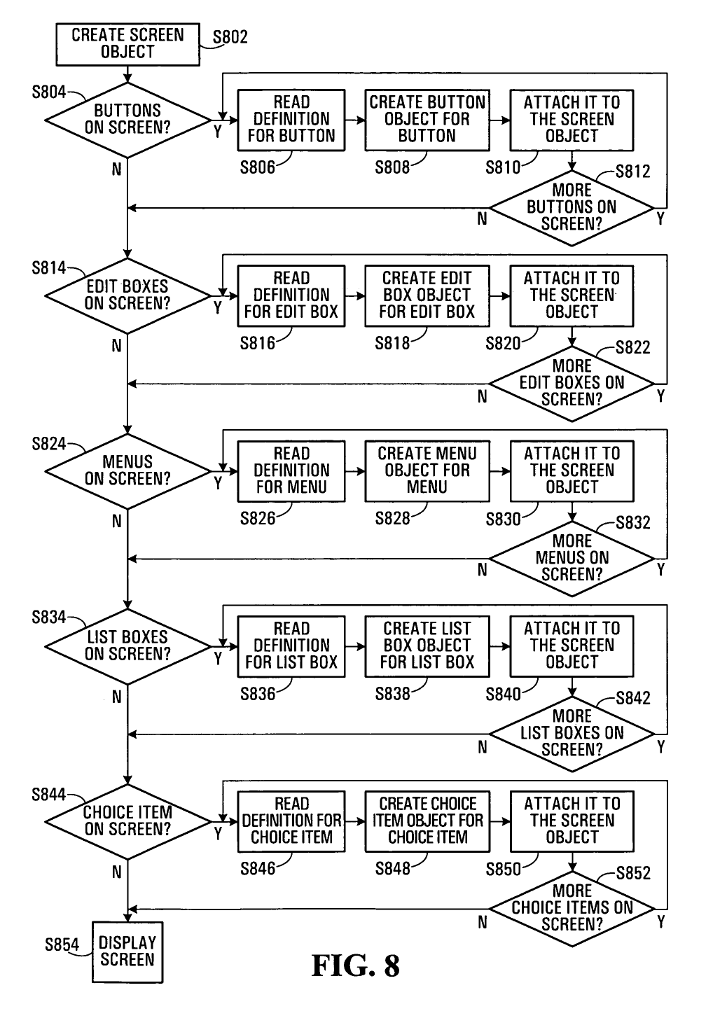

Exemplary steps performed by the virtual machine 24 in processing the initial screen (and any screen) are illustrated in FIG. 8. As illustrated, the screen generation engine 67 generates an instance of an object class, defining a screen by parsing the section of the application definition file corresponding to the <SCREEN> tag in step S802. Supported screen elements may be buttons, edit boxes, menus, list boxes and choice items, as identified in sections 5.3, 5.4 and 5.5 of Appendix “A”. Other screen elements, such as images and checkboxes, as detailed in Appendix “A”, may also be supported. However, for clarity of illustration, the processing of the other screen elements by the screen generation engine 67 is not detailed. Each supported tag under the SCREEN definition section, in turn, causes creation of instances 69 of object classes within the virtual machine 24. Typically, instances of objects corresponding to the tags, used for creation of a screen, result in presentation of data at the mobile device 10. As well, the creation of such instances may give rise to events (e.g., user interaction) and actions to be processed at the device 10.

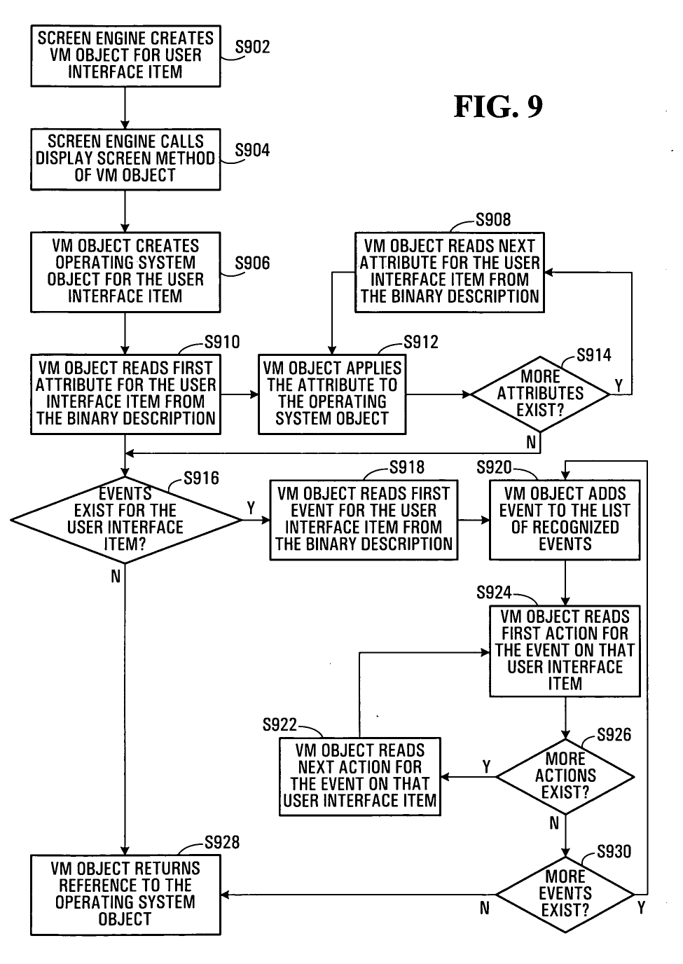

Each element definition causes the virtual machine 24 to use the operating system of the mobile device 10 to create a corresponding display element of a graphical user interface as more particularly illustrated in FIG. 9. Specifically, for each element, the associated XML definition is read in step S806, S816, S826, S836, and S846, and a corresponding instance of a screen object defined as part of the virtual machine software is created by the virtual machine 24 in steps S808, S818, S828, S838 and S848, in accordance with steps S902 and onward illustrated in FIG. 9. Each interface object instance is created in step S902. Each instance takes as attribute values defined by the XML text associated with the element. A method of the object is further called in step S904 and causes a corresponding device operating system object to be created. Those attributes defined in the XML text file, and stored within the virtual machine object instance, are applied to the corresponding instance of a display object created using the device operating system in steps S908S-S914. These steps are repeated for all attributes of the virtual machine object instance. For any element allowing user interaction, giving rise to an operating system event, the event handler 65 of the virtual machine 24 is registered to process operating system events, as detailed below.

Additionally, for each event (as identified by an <EVENT> tag) and action (as identified by an <ACTION> tag) associated with each XML element, the virtual machine 24 creates an instance of a corresponding event object and action object forming part of the virtual machine software. The virtual machine 24 further maintains a list identifying each instance of each event object and each action object, and an associated identifier of an event in steps S916 to S928.

Steps S902-S930 are repeated for each element of the screen in steps S808, S818, S828, S838 and S848 as illustrated in FIG. 8. All elements between the <SCREEN> definition tags are so processed. After the entire screen has been so created in memory, it is displayed in step S854, using conventional techniques.

As will be appreciated, objects are specific to the type of device executing the virtual machine software. Functions initiated as a result of the XML description may require event handling. This event handling is processed by the event handler 65 of the virtual machine 24 in accordance with the application definition file 28. Similarly, receipt of data from a mobile network will give rise to events. The event handler 65, associated with a particular application presented at the device, similarly processes incoming messages for that particular application. In response to the events, the virtual machine 24 creates instances of software objects and calls functions of those object instances, as required by the definitions contained within the XML definitions contained within the application definition file 28, giving rise to the event.

As noted, the virtual machine software 29 includes object classes, allowing the virtual machine 24 to create object instances corresponding to an <EVENT> tag. The event object classes include methods specific to the mobile device that allow the device to process each of the defined XML descriptions contained within the application definition file and also allow the device to process program/event flow resulting from the processing of each XML description.

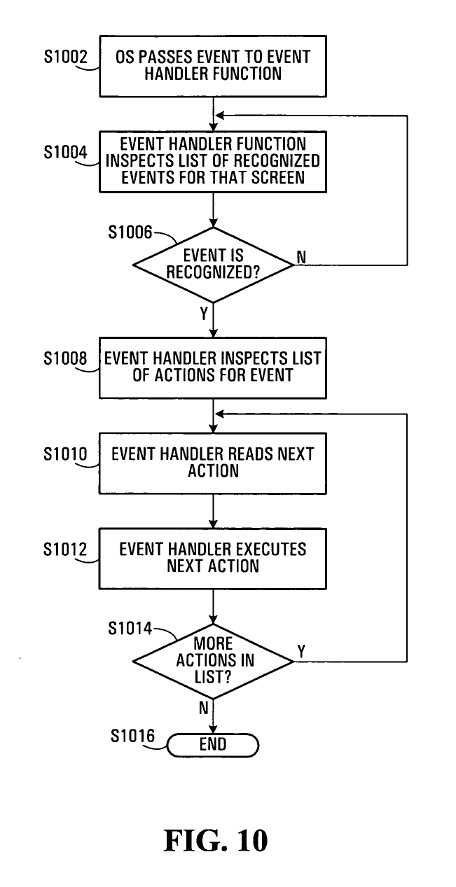

Events may be handled by the virtual machine 24 as illustrated in FIG. 10. Specifically, as the event handler 65 has been registered with the operating system for created objects, upon occurrence of an event, steps S1002 and onward are performed in response to the operating system detecting an event.

An identifier of the event is passed to the event handler 65 in step S1002. In steps S1004-S1008, this identifier is compared to the known list of events, created as a result of steps S916-S930. For an identified event, actions associated with that event are processed in step S1008-S1014. That is, the virtual machine 24 performs the action defined in the <ACTION> tag associated with the <EVENT> tag corresponding to the event giving rise to processing by the event handler 65. The <ACTION> may cause creation of a new screen, as defined by a screen tag, a network transmission, a local storage, or the like.

New screens, in turn, are created by invocation of the screen generation engine 67, as detailed in FIGS. 8 and 9. In this manner, the navigation through the screens of the application is accomplished according to the definition embodied in the application definition file.

Similarly, when the user wishes to communicate with the middleware server 44, or store data locally, the event handler 65 creates instances 69 of corresponding object classes of the virtual machine software 29 and calls methods of the instances to transmit the data, or store the data locally, using the local device operating system. The format of the data stored locally is defined by the local data definition section 52; the format of XML packages transmitted or received is defined in the network transaction package definition section 50.

For example, data that is to be sent to the wireless network is assembled into XML packages using methods of an instance of an XML builder object. Methods defined in as part of the XML builder object allow creation of a full XML package before passing the completed XML package to an instance of a message server object. The message server object instance uses the device's network APIs to transmit the completed XML package across the wireless network.

XML packages received from the data network 63 (FIG. 6) give rise to events processed by the event handler 65. Processing of the receipt of XML packages is not specifically illustrated in FIG. 9. However, the receipt of a XML package triggers a “data” event recognized by the device operating system 20 (see FIG. 1). This data event is passed to the virtual machine 24 and the event handler 65 inspects the received XML package. As long as the data received is a valid XML data package as contained within the application definition file, the virtual machine 24 inspects the list of recognized XML entities.

So, for example, a user could trigger the transmission of a login request (data flow 80, FIG. 7) by interacting with an initial login screen, defined in the application definition file for the application. The login request (data flow 80) would be passed by the middleware server 44 to the backend application server 70. The backend application server 70, according to the logic embedded within its application, would return a login response (data flow 82), which the middleware server 44 would pass to the virtual machine 24. Other applications, running on the same or other application servers might involve different interactions, the nature of such interactions being solely dependent on the functionality and logic embedded within the backend application server 70 and remaining independent of the middleware server 44.

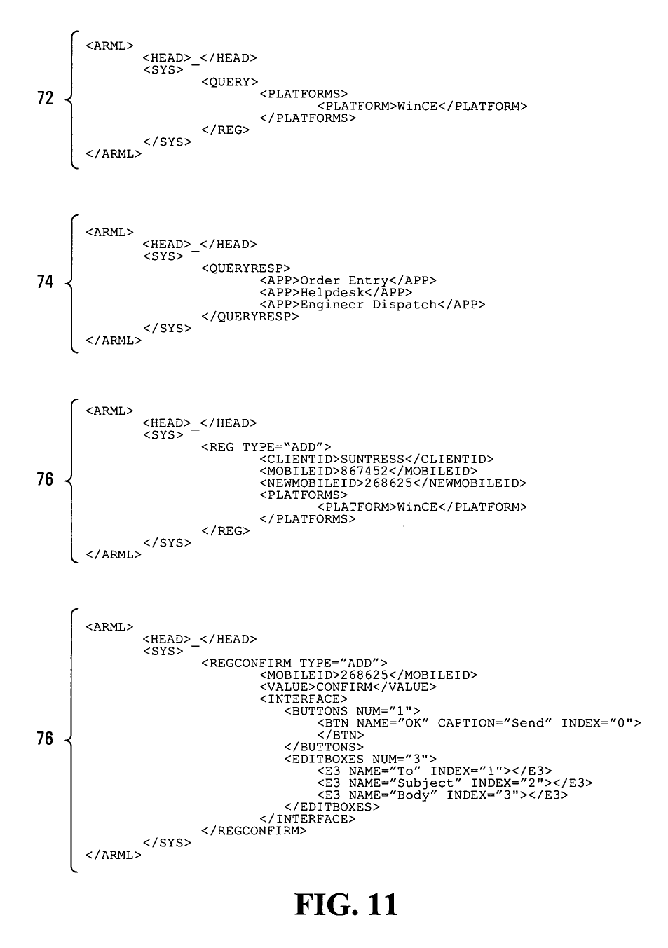

FIG. 11 illustrates example XML messages passed as part of the message flows illustrated in FIG. 7. For each message, the head element, i.e., the portion enveloped by the <HEAD></HEAD> tag pair, is considered to contain a timestamp and an identifier of the sending device.

A first example message 72 is representative of a message sent by the mobile device 10 to request the list of applications that the middleware server 44 has available to that user on that device. The first example message 72 specifies a type for the mobile device 10 using text contained by the <PLATFORM></PLATFORM> tag pair. A second example message 74 is representative of a message sent, to the mobile device 10 by the middleware server 44, in response to the first example message 72. The second example message 74 contains a set of <APP></APP> tag pairs, each tag pair enveloping an identity of a single application that is available to the user at the device 10. A third example message 76 is representative of a message sent from the mobile device 10 to the middleware server 44 to request registration for a single server side application. The tags specify information about the user and the mobile device 10. A fourth example message 78 is representative of a message sent, to the mobile device 10 by the middleware server 44, in response to the third example (registration request) message 76. The <VALUE></VALUE> tag pair envelope a code indicating success or failure. In the fourth example message 78 shown, a success is indicated by “CONFIRM” and is followed by an interface description for the application, enveloped by the

<INTERFACE></INTERFACE> tag pair. This interface description may then be stored locally within the storage memory 16 of the mobile device 10.

As noted, when a user starts an interface to an application, an application definition file for which has been downloaded in the manner described above, the virtual machine 24 reads the interface description section of the application definition file. The virtual machine 24 identifies the screen that should be displayed on startup and displays the elements of the screen as detailed in relation to FIGS. 9 and 10. The user may then use the functionality defined by the application definition file to send XML packages to, and receive XML packages from, the associated backend application server via the middleware server 44.

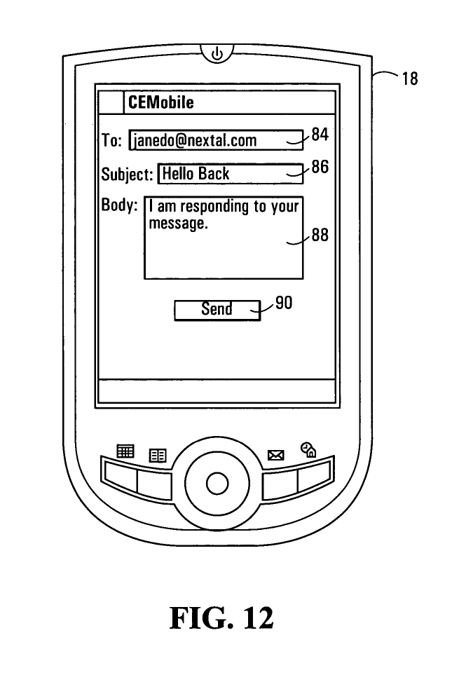

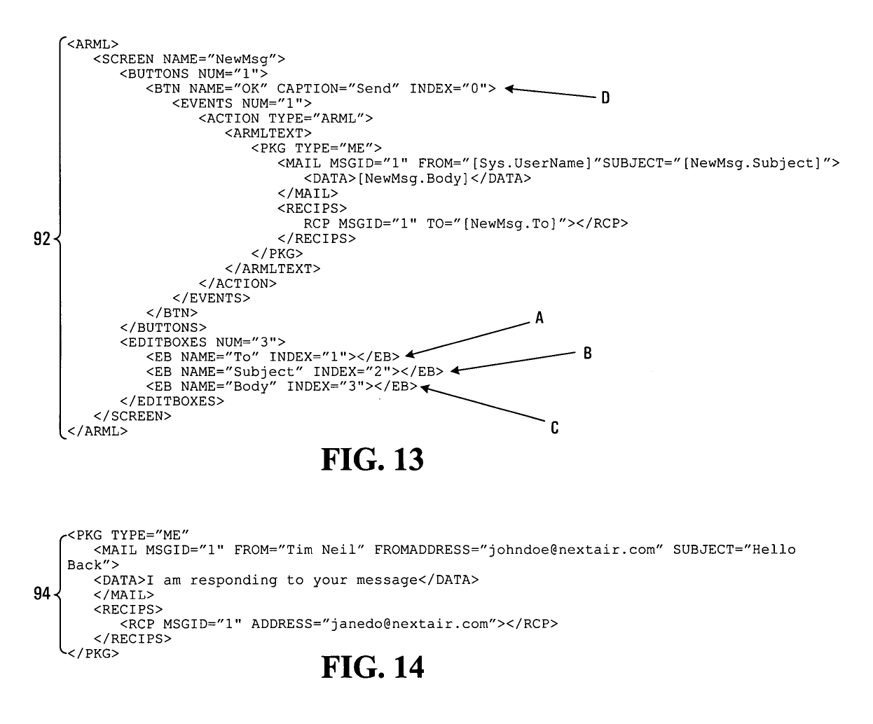

For the purposes of illustration, FIGS. 12 and 13 illustrate the presentation of a user interface for a sample screen on a Windows CE Portable Digital Assistant. As illustrated in FIG. 13, a first XML portion 92 of the application definition file 28 is an interface description for a screen with the name “NewMsg”. This interface description may be contained within the user interface definition section 48 of the application definition file 28 associated with the server side application. The screen is defined to have a single button identified by a <BTN> tag with attributes NAME=“OK”, CAPTION=“Send” and INDEX=“0”, which is identified as item D in FIG. 13. This button gives rise to a single event (identified by the <EVENTS> tag with attribute NUM=“1”) that has a single associated action (defined by the <ACTION> tag with attribute TYPE=“ARML”). This action results in the generation of an XML package (defined by the <PKG> tag with attribute TYPE=“ME”), which has a data format as defined enveloped by the <PKG></PKG> tag pair. The package is defined to begin with a <MAIL> TAG with attributes MSGID, FROM and SUBJECT. Additionally, the interface description for the screen includes definitions for three edit boxes, as enveloped by the <EDITBOXES></EDITBOXES> tag pair with attribute NUM=3. The definitions for the three edit boxes are identified in FIG. 13 as XML tag pairs A, B and C.

Upon invocation of the interface to the server side application at the mobile device 10, the screen generation engine 67 of the virtual machine 24 processes the interface definition for the screen, as detailed with reference to FIGS. 8 and 9. That is, for XML tag D, the screen generation engine 67 creates a button object instance in accordance with steps S804-S812. Similarly for XML tag pairs A, B and C within the application definition file 28, the virtual machine 24 creates instances of edit box objects (i.e., steps S834-S842, see FIGS. 8 and 9). The data contained within the object instances reflects the attributes of the relevant button and edit box tags, contained in the application definition file 28 associated with the server side application.

The resulting screen presented by the user interface 18 of the mobile device 10 is illustrated in FIG. 12. The user interface 18 depicts a screen called “NewMsg”, which uses interface items that provide a user with an ability to compose and send data. The screen illustrated in FIG. 12 has an edit box named “To” 84 corresponding to XML tag pair A in FIG. 13, an edit box named “Subject” 86 corresponding to XML tag pair B in FIG. 13 and an edit box named “Body” 88 corresponding to XML tag pair C in FIG. 13. The screen illustrated in FIG. 12 also incorporates a button named “OK” 90 corresponding to XML tag D in FIG. 13.

Call-backs associated with the OK button 90 cause graphical user interface application software, as part of the operating system at the mobile device 10, to return control to the event handler 65 of the virtual machine 24. Thus, as the user interacts with the user interface 18, the user may input data within the presented screen using the mobile device API. Once data is to be exchanged with the middleware server 44, the user may press the OK button 90 and, by doing so, invoke an event, which is initially handled by the operating system of the mobile device 10. However, during the creation of the OK button 90, in steps S804-S810, any call-back associated with the button was registered to be handled by the event handler 65 of the virtual machine 24. Upon completion, the virtual machine 24 receives data corresponding to the user's interaction with the user interface 18 and packages this data into an XML package using corresponding objects. The XML package is populated according to the rules within the application definition file 28.

The event handler 65, in turn, processes the event caused by user interaction with the OK button 90 in accordance with the <EVENT> tag and corresponding <ACTION> tag associated with the <BTN> tag, referenced as XML tag D, associated with the OK button 90. The events, and associated actions, are listed as data items associated with the relevant user interface item within the application definition file 28. The <ACTION> tag causes the virtual machine 24 to create an instance of an object that forms an XML package for transmission to the middleware server 44 in accordance with the format defined within the <ACTION></ACTION> tag pair. That is, a “template” (defined beginning with the <PKG> tag with attribute TYPE=“ME”) for the XML package to be sent is defined within the <EVENT></EVENT> tag pair for a given user interface item. This template specifies the format of the XML package to be sent and may include certain variable fields. The variable fields in the formatted XML package take on contents that vary according to the values received in data entry fields on the current and previous screens. The definition of the template specifies which data entry field should be interrogated to populate a given variable field within the XML package that is to be sent.

According to the template, some of the variable fields of the XML package are filled dynamically from data inserted by the user into edit boxes presented on the display of the mobile device 10. The template includes placeholders delimited by square brackets, i.e., “[” and “]”. These placeholders reference a data source from which data for filling the corresponding section of the template should be obtained. A suitable data source might be a user interface field on the current screen, a user interface field on a previous screen or a table in a device-based logical database. The virtual machine 24, after reading the data source name, searches for the field corresponding to the referenced data source and replaces the placeholder with data contained within the named field. For example, the SUBJECT attribute of the <MAIL> tag in the first XML portion 92 references [NewMsg.Subject]. As such, content for the SUBJECT attribute may be read from the edit box (field) named “Subject” on the screen named “NewMsg”. This process is repeated for each such placeholder, until the virtual machine 24, reading through the template, has replaced all placeholders in the template with content to form an XML package.

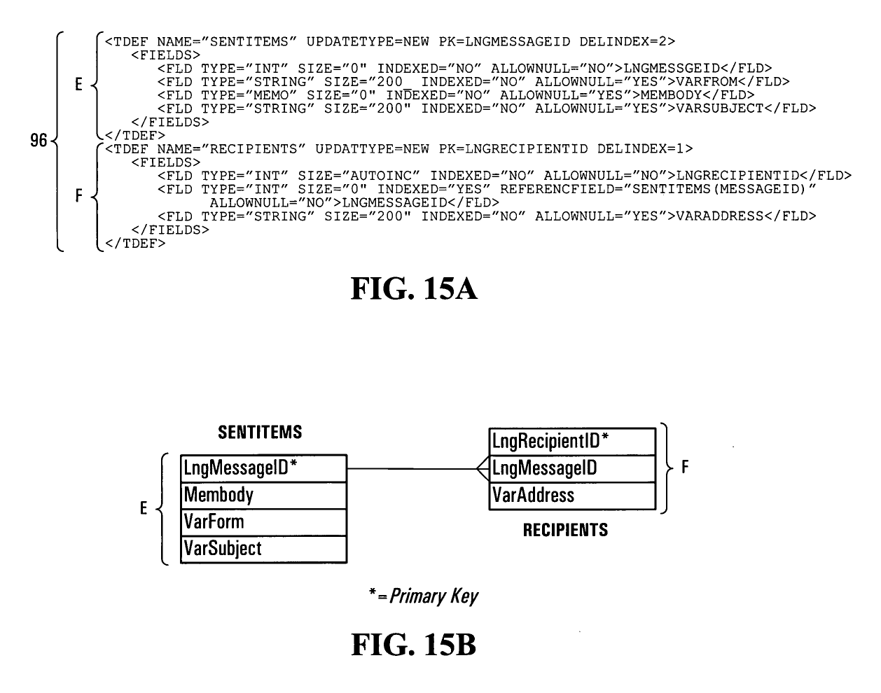

An exemplary XML package 94, containing data obtained as a result of input provided to the fields of the “NewMsg” screen, is illustrated in FIG. 14. The exemplary XML package 94 may have been created responsive to user interaction with the “NewMsg” screen, which user interaction may be considered to have been culminated by interaction with the OK button 90 (see FIG. 12) corresponding to XML tag D in the first XML portion 92. In this case, the user has entered: the text “janedoe@nextair.com” into the edit box named “To” 84; the text “Hello Back” into the edit box named “Subject” 86; and the text “I am responding to your message” into the edit box named “Body” 88.

The virtual machine 24, using the template, inspects these three edit boxes and places the text contained within each edit box in the appropriate position in the template. For example, the placeholder [NewMsg.Subject] is replaced by “Hello Back”. The virtual machine 24 creates the exemplary XML package 94 by invoking functionality embedded within an XML builder software object to populate the variable fields of the template contained in the first XML portion 92. Once the exemplary XML package 94 has been assembled in this fashion, a relevant method of the message server object is invoked to transmit the exemplary XML package 94 across the network.

When an XML package is received, the event handler 65 of the virtual machine 24 is notified. In response, the virtual machine 24 the XML parser 61 to build a list of name value pairs contained within the received XML package. Thereafter, methods within an object class for processing incoming XML packages are invoked that allow the virtual machine 24 to inspect the XML package to determine a server side application to associate with the XML package and select a corresponding application definition file. The methods within the object class for processing incoming XML packages also allow the virtual machine 24 to inspect the application definition file to identify the fields in the device-based logical database and the user interface screens that may need to be updated with new data received in the XML package. In the case wherein the user interface screens are updated, such updating may be accomplished according to the procedures normal to the particular device.

Handling of incoming XML packages is defined in the application definition file 28. That is, for each of the possible XML packages that can be received, the application description file 28 includes definitions of device-based logical database tables and screen items that should be updated, as well as which section of the package updates which device-based logical database table or screen item. After an XML package has been received, the event handler 65 uses rules based on the application description file 28 to identify which device-based logical database tables or screen items need to be updated.

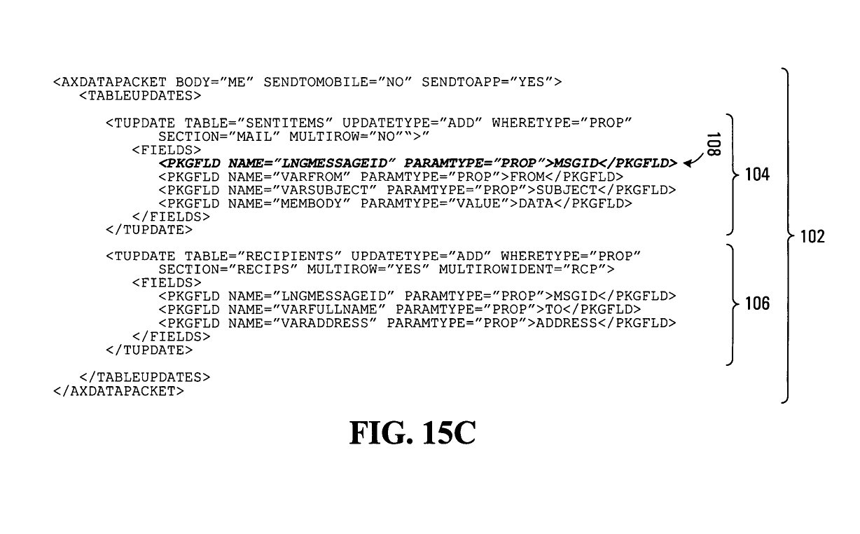

FIGS. 15A-15C illustrate how the format of the logical database in the local storage 26 on the device 10, and the XML packages that update the logical database, are defined in the application definition file 28. A second XML portion 96 of the application definition file 28, illustrated in FIG. 15A, forms part of the local data definition section 52 (see FIG. 4). The second XML portion 96 defines an example format for a portion of the logical database related to the e-mail application interface described with reference to FIGS. 12 and 13.

Two example tables are defined in the second XML portion 96 of FIG. 15A for formatting the logical database for the e-mail application. A first XML item E of the second XML portion 96 corresponds to a first table, labeled “SENTITEMS” in FIG. 15B. A second XML item F of the second XML portion 96 corresponds to a second table, labeled “RECIPIENTS” in FIG. 15B. The first table stores details of sent e-mail messages and has four fields. The second table stores recipients of sent e-mail messages and has three fields.

FIGS. 15A and 15B illustrate the use of the local storage 26 to store data related to XML packages that are sent and received. Specifically, the first table, defined by the first XML item E in FIG. 15A, may store the e-mail message contained in the exemplary XML package 94, shown in FIG. 14. Accordingly, the application definition file 28 for the e-mail application may be required to contain, along with the first XML portion 92 and the second XML portion 96, a third XML portion 102, illustrated in FIG. 15C. The third XML portion 102 defines how the data packages, composed according to the template included in the first XML portion 92 (see FIG. 13), lead to updates of the tables defined by the second XML portion 96.

The third XML portion 102 includes a first section 104 and a second section 106. The first section 104 defines how fields of a received XML package may be used to update the first table of FIG. 15B. An example line 108 defines how the “MSGID” field of the received XML package may be used to update a field named “LNGMESSAGEID” in the first table of FIG. 15B. Similarly, the second section 106 defines how the fields of the received XML package may be used to update fields of the second table of FIG. 15B.

The third XML portion 102 is contained by an <AXDATAPACKET></AXDATAPACKET> tag pair. Attributes of the <AXDATAPACKET> tag provide rules that instruct the virtual machine 24 as to whether data contained within an XML package of a given XML package type should be used to update tables in the device-based logical database. These rules may be applied whenever an XML package of the given XML package type is sent or received.

As can be seen from the preceding description and example, such an approach has significant advantages over traditional methods of deploying applications onto mobile devices. First, the definition of an application's functionality is separated from the details associated with implementing such functionality, thereby allowing the implementers of a mobile application to concentrate on the functionality and ignore implementation details. Second, application definition files can be downloaded wirelessly, wherever the device happens to be at the time at which the functionality is required. This greatly improves the usefulness of the mobile device, by removing reliance on returning the device to a cradle and running a complex installation program. Third, the use of application definition files allows flexible definitions for numerous applications. Server side applications may be easily ported to a number of device types.

Generally, it is known to generate application definition files that are platform-specific. In particular, an application definition file may incorporate particular user interface (UI) features or aspects, broadly called “screen control elements” herein, whose definitions are dictated by, or influenced by, platform-specific limitations. Where the application definition file is prepared in XML, the screen control elements are included in a DEV element, delimited by <DEV></DEV> tags. More than one DEV element may be included within a DEVICES element delimited by <DEVICES></DEVICES> tags.

Screen control elements may include, but are not limited to: buttons, textitems, editboxes, grids, choices, listboxes, checkboxes and menus.

Indeed, while it may be technically possible to make use of a given application definition file, which has been created for a mobile device having a first platform, on a mobile device having a second platform, the UI screens displayed by the resulting application may appear peculiar. For example, on the mobile device having the second platform, buttons may be crowded or UI real estate may go unused. Such peculiarity may be considered to be due to differences in UI limitations between the first platform and the second platform.

Additionally, certain screen control elements supported by the first platform may be unsupported by the second platform, or may be supported under a different name. Consequently, the unsupported screen control elements may be ignored by the mobile device having the second platform. To tailor interaction with a server side application to the mobile device having the second platform, it may be considered important to develop a separate version of the given application definition file, where the separate version includes a DEV element that is specific to the second platform. Disadvantageously, developing the separate version may entail significant effort.

However, with foreknowledge of UI limitations associated with at least a first platform and a second platform, a conversion tool (a software application) may automatically convert (or “port”) at least one screen control element, which, as defined in a DEV element for the first platform, is unsupported on the second platform, to a screen control element that is supported on the second platform. Alternatively, attributes of a given screen control element may be adjusted so as to suit the UI limitations associated with the second platform.

In overview, an application definition file management tool may pass a DEV element, selected through interaction with a user from a given application definition file, to a conversion tool that implements aspects of the application. The conversion tool receives the DEV element developed for a first platform (a source platform) and ports (converts) the source-platform-specific DEV element to a DEV element for a second platform (a destination platform) to create a destination-platform-specific DEV element. The conversion tool may return the destination-platform-specific DEV element to the application definition file management tool. The application definition file management tool may then add the destination-platform-specific DEV element to the DEVICES element of the given application definition file to produce a converted application definition file.

An exemplary UI limitation is screen resolution. That is, there may be a difference between a screen resolution of the source platform and a screen resolution of the destination platform. Where the source-platform-specific DEV element defines a screen control element based on the screen resolution of the source platform, the conversion tool may convert the screen control element definition to a definition that is better suited to the screen resolution of the destination platform. Optionally, while converting the screen control element definition, the conversion tool may preserve the proportionality of the UI screen.

In another instance, a UI screen may be defined for the source platform to include a grid and an edit box, which are screen control elements supported by the PocketPC platform. However, the grid and edit box screen control elements are not supported by all platforms. As such, while performing conversion, the conversion tool may select screen control elements that are supported by the destination platform to substitute for the screen control elements that are unsupported.

In a further instance, a UI screen for the source platform may be defined to include a combination of several screen control elements. The destination platform may support each of the screen control elements, but may not support the defined combination. As such, while performing conversion, the conversion tool may separate a first set of screen control elements for presentation on a first screen and at least one other set of screen control elements for presentation on one or more further screens.

Optionally, the conversion tool may generate output that provides an indication of screen control elements in the source-platform-specific DEV element that have been converted and screen control elements in the source-platform-specific DEV element that have not been converted. The conversion tool may also provide an indication of the manner in which potentially problematic conversions have been handled.

Screen controls may be defined, in corresponding screen control elements in a source-platform-specific DEV element, to be presented side-by-side, where such side-by-side presentation is supported by the source platform. For example, buttons may be defined to be presented side-by-side. Additionally, a label may be defined to be presented beside an edit box. Where such side-by-side presentation is not supported by the destination platform, the conversion tool may arrange for the stacking of the screen control elements in the destination-platform-specific DEV element.

Appendix B provides an exemplary initial application definition file named “StockTicker_before.xml”. The exemplary initial application definition file includes a source-platform-specific DEV element delimited by <DEV></DEV> tags. Specifically, the initial <DEV> tag includes an attribute, TYPE=“CE”, that indicates a type for the source platform.

Appendix C provides an exemplary converted application definition file named “StockTicker_after.xml”. That is, StockTicker_after.xml is the output of an application definition file management tool incorporating a conversion tool that implements aspects of the application given the DEV element in StockTicker_before.xml as input. The exemplary converted application definition file includes two platform-specific DEV elements. The source-platform-specific DEV element (with attribute TYPE=“CE”) remains from the exemplary initial application definition file, while a destination-platform-specific DEV element has been added with an initial <DEV> tag that includes an attribute, TYPE=“PALM”, that indicates a type for the destination platform.

In consideration of a BTN screen control element with a NAME attribute set to “btnGetQuote” in StockTicker_after.xml, a comparison may be made of lines 45-46, which define the button for the CE platform, and lines 234-235, which define the button for the PALM platform. In particular, dimensions for the two buttons are defined as follows:

CE: X=“19” Y=“215” HT=“20” WT=“90”; and

PALM: X=“12” Y=“114” HT=“11” WT=“60”.

A comparison may also be made for a BTN screen control element with a NAME attribute set to “btnQuit”, at lines 62-63, which define the button for the CE platform, and lines 251-252, which define the button for the PALM platform. In particular, dimensions for the two buttons are defined as follows:

CE: X=“131” Y=“215” HT=“20” WT=“90; and

PALM: X=“87” Y=“114” HT=“11” WT=“60”.

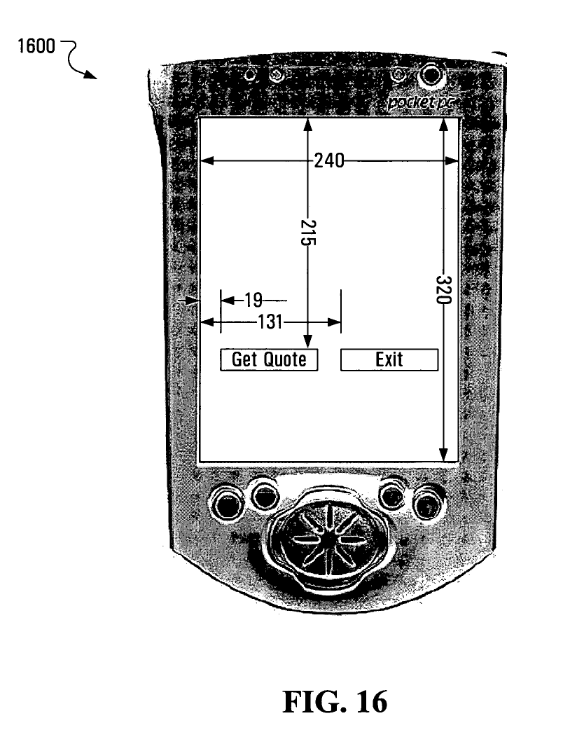

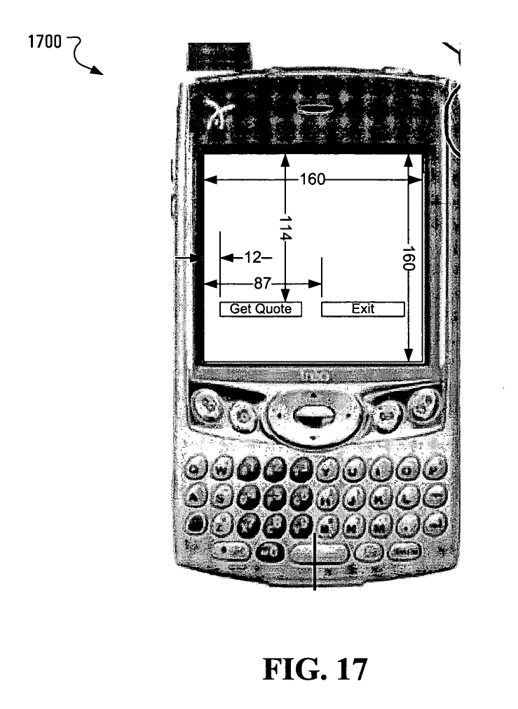

A reason for the conversion can be found in the typical dimensions of screens for PocketPC (CE) devices and Palm devices. As illustrated in FIG. 16, a typical PocketPC device 1600 has a screen resolution of 240×320 pixels. As illustrated in FIG. 17, a typical Palm device 1700 has a screen resolution of 160×160 pixels. The CE-platform-specific DEV element defines the position of the button corresponding to the BTN screen control element with a NAME attribute set to “btnGetQuote” as 19 pixels to the right of the left edge of the screen (X) and 215 below the top edge of the screen (Y). The CE-platform-specific DEV element also defines the position of the button corresponding to the BTN screen control element with a NAME attribute set to “btnQuit” as 131 pixels to the right of the left edge of the screen and 215 below the top edge of the screen.

If the CE-platform-specific DEV element was employed by a virtual machine executed on the Palm device 1700, neither button would appear on the screen, since the offset from the top of the screen (215) is greater than the vertical screen dimension (160).

So that the buttons may appear of the screen of the Palm device 1700, the conversion tool may perform a conversion of the definitions of the BTN screen control elements as part of generating a PALM-specific DEV element. Initially, the conversion tool may adjust the horizontal dimensions (X, WT) by a conversion ratio (2:3) of the horizontal screen dimension of the PALM device (160) to the horizontal dimension of the PocketPC device (240). Similarly, the conversion tool may adjust the vertical dimensions (Y, HT) by a conversion ratio (1:2) of the vertical screen dimension of the PALM device (160) to the vertical dimension of the PocketPC device (320).

For example, the conversion tool may multiply the value of the attribute that is representative of an offset (X=19) from the left edge of the screen, which is part of the definition of the BTN screen control element with a NAME attribute set to “btnGetQuote”, by the horizontal conversion ratio (2:3) to obtain a value (12.6). The conversion tool may then truncate the value to form a new horizontal offset value (12) for use in defining the BTN screen control element with a NAME attribute set to “btnGetQuote” in the PALM-specific DEV element.

For a further example, the conversion tool may multiply the value of the attribute that is representative of a height (HT=20), which is part of the definition of the BTN screen control element with a NAME attribute set to “btnGetQuote”, by the vertical conversion ratio (1:2) to obtain a new height value (10).

Notably, the new height value used in defining the BTN screen control element with a NAME attribute set to “btnGetQuote” in the PALM-specific DEV element is 11. This difference may be explained in that, once a new value is determined based on multiplication by a ratio, it may further be considered whether the value is within limits defined in guidelines for the device. For instance, a button that is 10 pixels in height may not be large enough to display a caption in a default system font for the device. In such a case, the conversion tool may adjust the value of the dimension to be within limits defined in guidelines for the device. Furthermore, the conversion tool may adjust positioning dimensions to produce an acceptable screen control layout. That is, a preferred distance (buffer) between buttons may be defined in the guidelines.

Elsewhere in the destination-platform-specific DEV element, at line 261, the conversion tool has renamed a menu, which has a NAME attribute set to “mnuHelp” (see line 72) in the CE platform-specific DEV element, as a menu with a NAME attribute set to “File” in the PALM platform-specific DEV element. In this case, the conversion tool has defined a new MENU screen control element by replacing the value of the NAME attribute used for the CE platform with a static menu name known to be used in a virtual machine developed specifically for the PALM platform.

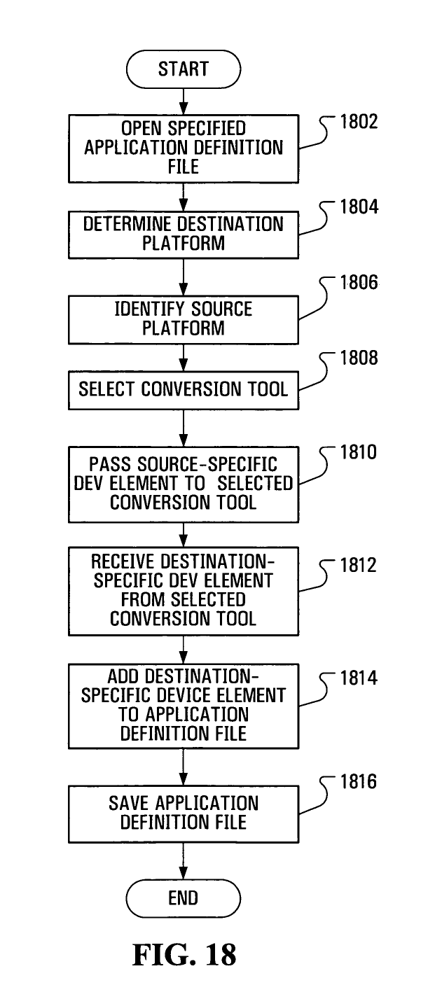

In operation, through interaction with a user, the application definition file receives a file name and a location for an application definition file, for example, StockTicker_before.xml (Appendix B). Responsively, the application definition file is opened by the application definition file management tool (see step 1802, FIG. 18). Furthermore, the interaction with the user also provides the application definition file management tool with an indication of a DEV element to convert and the destination platform to which to convert the DEV element. In particular, if the interaction appears in relation to a screen presenting a list of application definition files, the user may select a particular application definition file and select a DEV element within the particular application definition file. Continuing the example of StockTicker_before.xml, the user may select the DEV element with attribute TYPE=“CE”, which occupies lines 40-228.

Responsive to user input, a right mouse click on the selected DEV element, for instance, the application definition file management tool may present a menu of options. One of the options may be “Convert to” and this option may be associated with several sub-options, where each of the sub-options identify a potential destination platform. By receiving such input from the user, the application definition file management tool may determine (step 1804), for example, that the required destination platform is the PALM platform.

The application definition file management tool may then parse the source-specific DEV element to determine the value of the TYPE attribute of the DEV element and, thus, identify the source platform (step 1806). Based on the source platform of the selected DEV element, CE, in the present example, and on the indicated destination platform, PALM, in the present example, the application definition file management tool may select (step 1808) a conversion tool specific to the required conversion. Such a conversion-specific tool may be developed to incorporate the knowledge of a developer of differences in limitations on the definitions of screen control elements. The application definition file management tool may then trigger the execution of the conversion-specific tool by passing the source-specific DEV element (step 1810) to the conversion-specific tool. The output of the conversion-specific tool is a destination-specific DEV element.

Upon receipt of the destination-specific DEV element (step 1812), the application definition file management tool may add the destination-specific DEV element to the DEVICES element of the application definition file (step 1814) to generate a converted application definition file and then save the converted application definition file (step 1816). In the present example, the converted application definition file is StockTicker_after.xml (Appendix C), which includes a PALM-platform-specific DEV element occupying lines 229-417.

As should be clear to a person of ordinary skill in the art, the trigger to the operation of the conversion tool is not limited to the above-described right mouse click request by the user. While viewing the screen presenting the list of application definition files, the user may select a particular application definition file and select a DEV element within the particular application definition file. Such selection may provide a cascading tree-like display of the elements within the DEV element. Typically, a SCREENS element within a DEV element includes several SCREEN elements. While the following describes conversion of an entire DEV element, which may contain several SCREEN elements, the conversion tool may equally perform a conversion on a single SCREEN element. Furthermore, rather than the right mouse click menu used to trigger conversion of an entire DEV element with a DEVICES element, the user may select a SCREEN element from a first DEV element and simply drag the on-screen representation of the SCREEN element and drop it on an on-screen representation of a second DEV element. The conversion tool would then receive the indication of the source platform and the destination platform by parsing the first and second DEV elements to determine the value of the TYPE attribute for each. As an alternative to the drag-and-drop operation, the on-screen representation of the SCREEN element may be cut or copied and then pasted to an on-screen representation of a second DEV element.

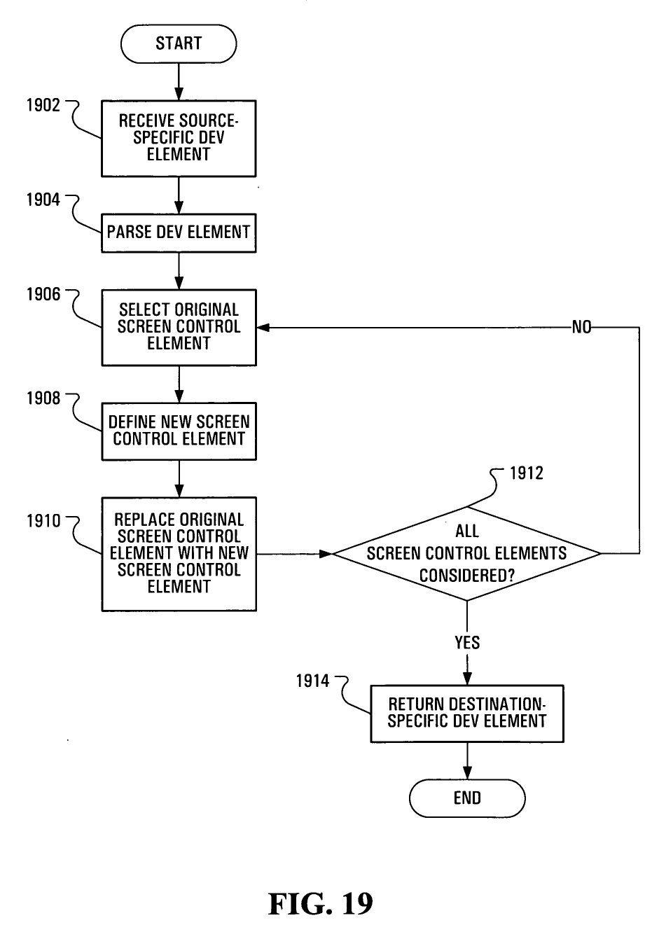

In view of FIG. 19, operation of a generic conversion-specific tool begins with the receipt of a source-specific DEV element (step 1902). In the present example, the source-specific DEV element is the DEV element with attribute TYPE=“CE”, which occupies lines 40-228 of StockTicker_before.xml. The conversion tool parses (step 1904) the received source-specific DEV element to identify screen control elements. In the case of the DEV element with attribute TYPE=“CE”, the screen control elements are buttons, menus, editboxes, textitems, choiceitems and queries.

The conversion tool may then select (step 1906), from the screen control elements identified by the parsing (step 1904), a screen control element that is determined, by the developer of the conversion tool, to require conversion. The screen control elements requiring conversion may thus be predetermined for the source platform and the destination platform for which the conversion-specific tool has been developed.

For example, where the source platform is the PocketPC (TYPE=“CE”) platform and the destination platform is the Palm (TYPE=“PALM”) platform, checkboxes may be considered to require conversion. In particular, when defining a new checkbox based on an original checkbox, the conversion tool may increase the size of the original checkbox to compensate for wider fonts on PALM devices; the conversion tool may also increase the width of the original checkbox label to compensate for the wider font size on PALM devices; the conversion tool should confirm that the checkbox height is at least 12 pixels; the conversion tool may remove whitespace at the start of a caption as such whitespace is not necessary on PALM devices; and the conversion tool may check PALM constraints. PALM constraints include: a maximum of three grids per screen; a maximum of four menus; and the menus have a NAME attribute set to “File”, “Edit”, “Options” or “View”, in that order.

The parsing (step 1904) may, for instance, involve the conversion tool reading each BTN screen control element in the DEV element into an indexed array of BTN screen control elements. In such a context, selecting an original screen control element (step 1906) may, for instance, involve the conversion tool assigning the value of the array at a particular index value to a screen control element variable. Selecting a subsequent original screen control element (step 1906) may involve the conversion tool incrementing the particular index value and assigning the value of the array at the incremented index value to the screen control element variable.

A new screen control element may then be defined (step 1908), by the conversion tool, based on the original screen control element. The defining (step 1908) may, advantageously, be arranged to incorporate limitations specific to the second platform.

Such defining by the conversion tool may, in one example, relate to scaling dimensions (height, width, position on screen) of the selected screen control element. As discussed above, for the BTN screen control element with the NAME attribute set to “btnGetQuote”, among other dimensions, the distance of the button from the left edge of the display, which is an attribute “X” in the BTN screen control element, has a value of 19 in the source-specific DEV element. The conversion tool may multiply the value of the dimension by a conversion ratio (2:3, in the example) to obtain a new value (12, in the example). The attribute may then be set to the new value by the conversion tool. That is, in the screen control element variable that stores a string representative of the BTN screen control element, the text representative of the value that is assigned to the attribute “X” (19) has been replaced with the text representative of the new value (12).

The defining (step 1908) by the conversion tool may, in another example, relate to substitution of a new screen control element for the original screen control element. One screen control element that is known to be supported by devices that utilize touch sensitive screens is the button, which is defined by a BTN screen control element. A BTN screen control element is typically associated with a CAPTION attribute, an EVENT element (i.e., with TYPE attribute set to “BUTTONCLICK”) and ACTION elements, execution of which is triggered when an event of the type identified in the EVENT element is detected by the event handler. When the XML code describing a set of buttons is encountered by a virtual machine executed by a device that does not support buttons, the XML code is typically ignored. A device that does not support buttons may have a physical user interface in the form of a scroll wheel in combination with a screen instead of a touch sensitive screen.

The defining (step 1908) by the conversion tool may, in another example, relate to layout of the screen controls. The case may be that two screen controls are defined, in a DEV element for the source platform, to be displayed side-by-side. For instance, a label for an editbox may be defined to appear to the left of an editbox screen control. Unfortunately, the destination platform may not support side-by-side display of screen controls, which may be the case if the destination platform only allows for a vertical layout of screen controls. The defining (step 1908) by the conversion tool may involve, in such a case, examining the X and Y attributes of each screen control element in a SCREEN element to determine the flow of the screen thus creating the proper flow in the vertical layout of the target device.

Accordingly, in the course of defining a new screen control element (step 1908), the conversion tool may replace the XML code describing a set of buttons with XML code describing a set of menuitems. A given BTN screen control element of the set of buttons, within a BUTTONS element, may be replaced, by the conversion tool, with a MENUITEM screen control element, as part of a MEN,U element.

It is typical for a BTN screen control element to have attributes such as NAME, CAPTION, INDEX, X, Y, HT and WT. It is also typical that a BTN screen control element have an associated EVENT element, for example, an EVENT element with a TYPE attribute set to “BUTTONCLICK”. Similarly, it is typical for a MENUITEM screen control element to have attributes such as NAME, CAPTION and INDEX and an associated EVENT element, for example, an EVENT element with a TYPE attribute set to “MENUITEMSELECTED”. BTN screen control elements are generally collected with a BUTTONS screen control element, while MENUITEM screen control elements are generally collected with a MENU screen control element.

To define a new MENUITEM screen control element based on an original BTN screen control element, the conversion tool may initially replace the <BTN></BTN> tags with <MENUITEM></MENUITEM> tags and eliminate the attributes X, Y, HT and WT, which do not have equivalents in the new MENUITEM screen control element. Furthermore, the conversion tool may replace the text value of the TYPE attribute of the EVENT element associated with the original BTN screen control element by setting the TYPE attribute to a text value appropriate to the new MENUITEM screen control element, for example, “MENUITEMSELECTED”. Additionally, the conversion tool may define a new MENU screen control element by substituting the text MENU for the text BUTTONS in the tags that define the boundaries of the BUTTONS screen control element surrounding the original BTN screen control element.

When the defining (step 1908) is complete, in the screen control element variable that originally stored a string representative of the BTN screen control element, the text (BTN) in the tag at the beginning of the element and at the end of the element has been replaced with new text (MENUITEM). Furthermore, the attributes X, Y, HT and WT of the original BTN screen control element have been eliminated and the text representative of the value (BUTTONCLICK) of the TYPE attribute of the EVENT element associated with the original BTN screen control element has been replaced with text representative of a value (MENUITEMSELECTED) of the TYPE attribute for an EVENT element consistent with the new type of screen control element. Additionally, the type of screen control element surrounding the original BTN screen control element has been changed from a BUTTONS screen control element to a MENU screen control element.

Advantageously, a virtual machine executed on a device that does not support buttons but is in receipt of an application definition file with a DEV element that includes the new MENUITEM screen control element, as defined above, may react to an occurrence of an event of the type associated with the new MENUITEM screen control element by performing the actions defined by ACTION elements originally associated with an event of the type associated with the original BTN screen control element.

The conversion tool may then replace (step 1910) the original screen control element with the new screen control element in the received source-specific DEV element, thereby producing a destination-specific DEV element. Where the original screen control element has been read into the screen control element variable and aspects of the screen control element variable have been replaced, the screen control element replacement may involve assigning the screen control element variable to the value of the array at the particular index value corresponding to the original screen control element.

It may then be determined (step 1912) whether all the screen control elements requiring conversion have been considered. If not, the conversion tool may select a further original screen control element (step 1906), define a further new screen control element (step 1908) and replace (step 1910) the further original screen control element with the further new screen control element. If all the screen control elements requiring conversion have been considered, the conversion tool may return (step 1914) the destination-specific DEV element to the application definition file management tool. Returning the destination-specific DEV element may involve first forming the destination-specific DEV element by assembling various arrays into which the elements of the were separated by the parsing (step 1904). Notably, some of the arrays will have been converted by the combined defining (step 1908) and replacing (step 1910).

As will be clear to a person of ordinary skill in the art, a more thorough source platform to destination platform conversion of an application definition file may consider elements beyond simply the screen control elements of a DEV element, such as flow control elements, action elements and table elements.

It will be understood that the invention is not limited to the embodiments described herein which are merely illustrative of a preferred embodiment of carrying out the invention, and which is susceptible to modification of form, arrangement of parts, steps, details and order of operation. The invention, rather, is intended to encompass all such modification within its scope, as defined by the claims.

We claim:

1. A method of converting a portion of a document, developed for configuring a first mobile communication device with a first platform, to generate a new document portion for configuring a second mobile communication device with a second platform, said method comprising:
receiving a portion of said first document, where said portion of said first document is specific to said first platform;
parsing said portion of said first document to identify a plurality of screen control elements;
defining a new screen control element based on an original screen control element from among said plurality of screen control elements, where said defining incorporates limitations specific to said second platform; and
replacing, in said portion of said first document, said original screen control element with said new screen control element.

2. The method of claim 1 wherein said original screen control element is unsupported by said second platform and where said new screen control element is supported by said second platform.

3. The method of claim 1 wherein said first platform is a PocketPC operating system.

4. The method of claim 1 wherein said second platform is a Palm operating system.

5. The method of claim 1 wherein said document is written in the eXtensible Markup Language.

6. The method of claim 5 wherein said original screen control element is a button.

7. The method of claim 5 wherein said original screen control element is a textitem.

8. The method of claim 5 wherein said original screen control element is an editbox.

9. The method of claim 5 wherein said original screen control element is a grid.

10. The method of claim 5 wherein said original screen control element is a choice.

11. The method of claim 5 wherein said original screen control element is a listbox.

12. The method of claim 5 wherein said original screen control element is a checkbox.

13. The method of claim 5 wherein said original screen control element is a menu.

14. The method of claim 5 wherein said original screen control element is of the same type as said new screen control element.

15. The method of claim 14 wherein said defining said new screen control element comprises scaling a dimension of said original screen control element.

16. The method of claim 15 wherein said dimension is related to a size of said original screen control element.

17. The method of claim 15 wherein said dimension is related to a position, on a screen of said first mobile communication device, of said original screen control element.

18. The method of claim 5 wherein said defining said new screen control element comprises substituting said new screen control element for said original screen control element, where said new screen control element is of a distinct type from said original screen control element.

19. A computing device comprising:
a processor;
computer readable memory in communication with said processor, storing software adapting said device to:
receive a portion of said first document, where said portion of said first document is specific to said first platform;
parse said portion of said first document to identify a plurality of screen control elements;
define a new screen control element based on an original screen control element from among said plurality of screen control elements, where said defining incorporates limitations specific to said second platform; and
replace, in said portion of said first document, said original screen control element with said new screen control element.

20. A computer readable medium containing computer-executable instructions that, when performed by processor, cause said processor to:
receive a portion of a first document, where said portion of said first document is specific to a first platform;
parse said portion of said first document to identify a plurality of screen control elements;
define a new screen control element based on an original screen control element from among said plurality of screen control elements, where said defining incorporates limitations specific to a second platform; and
replace, in said portion of said first document, said original screen control element with said new screen control element.
